(19) United States
(12) Patent Application Publication
(10) Pub. No.: US 2006/0269814 A1
(43) Pub. Date: Nov. 30, 2006

(54) Fuel cell membrane and fuel cells including same

(76) Inventors: Isaac B. Horton III, Raleigh, NC (US); Kenneth Smith, Colfax, WI (US)

Correspondence Address: MACCORD MASON PLLC, 300 N. GREENE STREET, SUITE 1600, P. O. BOX 2974, GREENSBORO, NC, 27402, US

(21) Appl. No.: 11/141,659

(22) Filed: May 31, 2005

(51) Int. Cl. H01M 8/10; B05D 5/12

(52) U.S. Cl. 429/30; 427/115

(57) ABSTRACT

A fuel-impermeable membrane for a fuel cell including a nano-film proton exchange membrane (PEM) having an energy loss of less than about 100 mA cm⁻² of active surface area, and the energy efficient fuel cell formed therewith, and methods of making same.

### BACKGROUND OF THE INVENTION

(1) Field of the Invention

The present invention relates generally to fuel cells and, more particularly, to a fuel cell membrane that is fuel-impermeable for improving energy efficiency by eliminating energy loss associated with the membrane permeability.

(2) Description of the Prior Art

Fuel cells require a membrane that is substantially fuel-impermeable in order to function effectively. However, prior art fuel membranes are not entirely fuel-impermeable, thus permitting fuel crossover through the membrane, which causes loss in power output of the fuel cell and also may cause poisoning of the membrane, electrodes, and other components of the fuel cell.

Fuel crossover rate is difficult at best to measure, at least with any form of accuracy. Nevertheless, a loss of about 100 mA cm⁻² for active proton exchange membrane (PEM) surface area is a generally accepted typical crossover rate; meaning that 100 mA of potential useable power for every square centimeter of membrane area is wasted. With a typical cell output of 500 mA cm⁻², the 100 mA loss is significant—approximately ⅙ of the available energy.

Thus, a need exists for a fuel cell membrane that is highly impermeable to fuels for reducing fuel cross-over and, correspondingly, improving energy efficiency and increased operational reliability of the fuel cell.

### SUMMARY OF THE INVENTION

The present invention is directed to a fuel cell and, more particularly, to a fuel cell membrane that is fuel-impermeable for improving energy efficiency by eliminating energy loss associated with the membrane permeability. In the preferred embodiment, the fuel-impermeable membrane is formed from nano-film deposition. Preferably, the membrane includes palladium, although other materials may be included.

The present invention is further directed to a method for making a fuel cell having a fuel-impermeable membrane, using a thin film or foil barrier or using nanotechnology for generating and applying the membrane within the cell.

The present invention is still further directed to a DFMC that is capable of using concentrated methanol as a fuel source.

Thus, the present invention provides fuel cells having fuel-impermeable membrane to eliminate power loss within the cell due to membrane leakage or permeability.

Accordingly, one aspect of the present invention is to provide a fuel cell having a membrane that is fuel-impermeable for improving energy efficiency by eliminating energy loss associated with the membrane permeability.

Another aspect of the present invention is to provide a method for making a fuel cell having a fuel-impermeable membrane using a thin film or foil barrier, or using nanotechnology for generating and applying the membrane within the cell.

Another aspect of the present invention is to provide a fuel cell membrane having a proton exchange membrane and a reinforcing layer for providing increased durability.

Still another aspect of the present invention is to provide a fuel cell with a methanol-impermeable barrier for minimizing methanol crossover within the fuel cell, thereby permitting the use of concentrated methanol as a fuel source for providing increased fuel volume to output power efficiency as well as fuel cell mass to power output.

Still another aspect of the present invention is to provide a DFMC that is capable of using concentrated methanol as a fuel source, wherein methanol crossover within the fuel cell is minimized due to the use of a fuel-impermeable membrane within the fuel cell.

These and other aspects of the present invention will become apparent to those skilled in the art after a reading of the following description of the preferred embodiment when considered with the drawings.

### BRIEF DESCRIPTION OF THE DRAWINGS

FIG. 1 is a schematic view of a fuel cell cross-section constructed according to the PRIOR ART.

FIG. 2 is a schematic diagram illustrating the operation of a fuel cell and membrane according to the PRIOR ART.

FIG. 3 shows a schematic diagram of a membrane electrode assembly according to the present invention.

FIG. 4 is schematic view of a fuel cell cross-section constructed according to the present invention.

FIG. 5 is a schematic diagram illustrating the operation of a fuel cell and membrane according to the present invention.

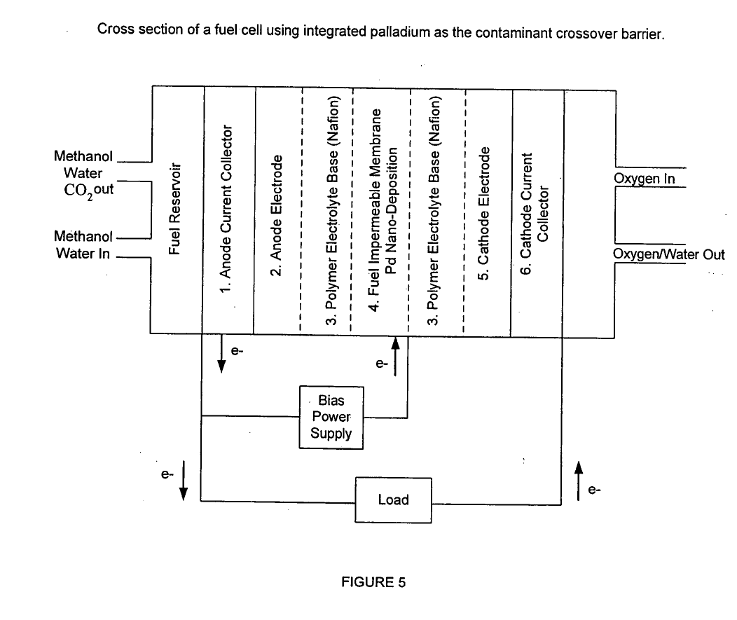

### DETAILED DESCRIPTION OF THE PREFERRED EMBODIMENTS

In the following description, like reference characters designate like or corresponding parts throughout the several views. Also in the following description, it is to be understood that such terms as “forward,” “rearward,” “front,” “back,” “right,” “left,” “upwardly,” “downwardly,” and the like are words of convenience and are not to be construed as limiting terms.

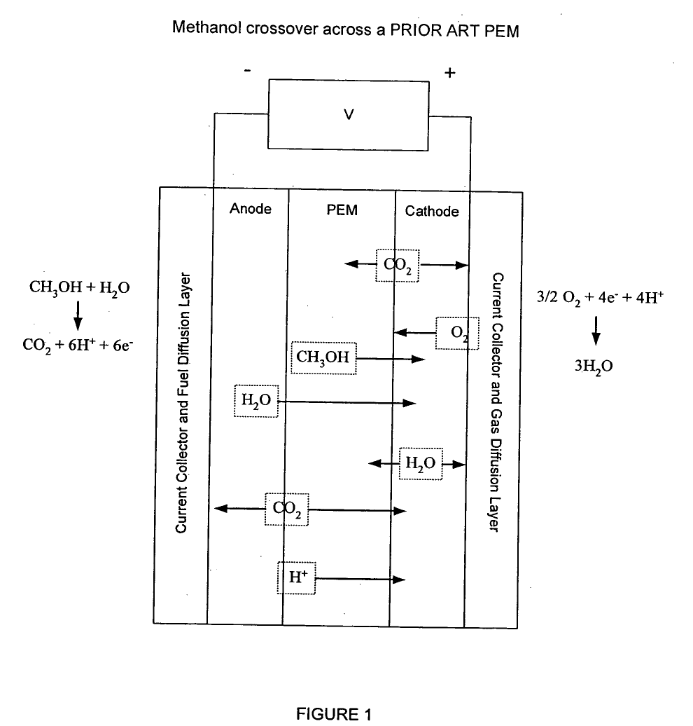

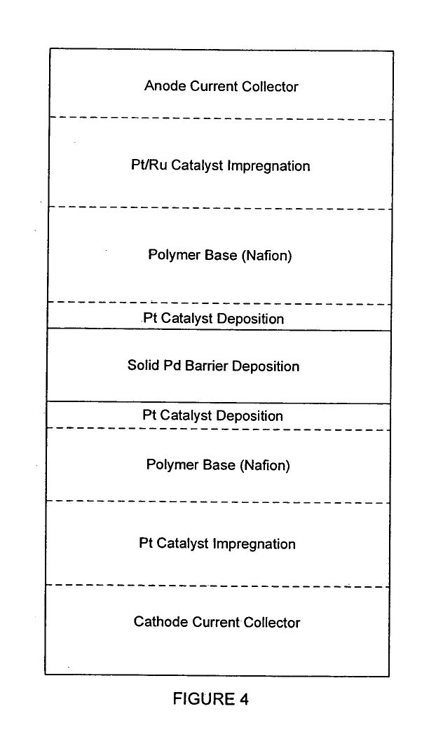

Referring now to the drawings in general, the illustrations are for the purpose of describing a preferred embodiment of the invention and are not intended to limit the invention thereto. As best seen in FIG. 1, a schematic view of a fuel cell cross-section constructed according to the PRIOR ART is shown. By contrast to the typical prior art fuel cell, the present invention, illustrated in FIG. 4, provides a fuel cell, generally referenced 10, having efficient electrochemical conversion including:

a fuel diffusion layer 12;

a fuel-impermeable membrane 20 for the fuel cell including

a proton exchange membrane (PEM) having an energy loss less than about 100

mA cm⁻² of active surface area, thereby providing an energy efficient fuel cell.

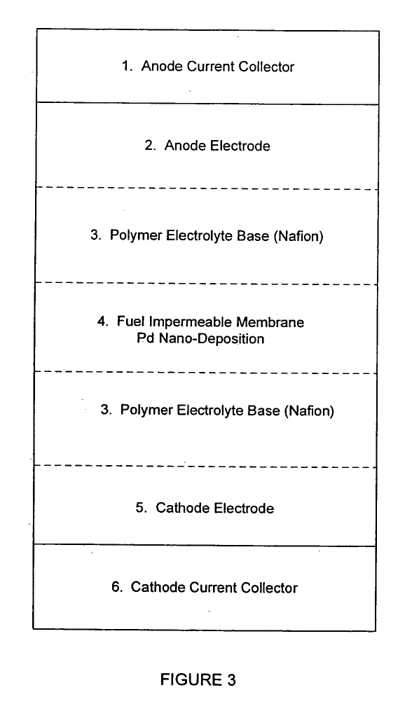

As shown in FIG. 3, components of the present invention include a membrane electrode assembly having:

1. an Anode Current Collector (ACC);

2. an Anode Electrode (AE);

3. a Polymer Electrolyte Base (PEB);

4. a Fuel Impermeable Membrane;

5. a Cathode Electrode; and

6. a Cathode Current.

Preferably, the ACC includes carbon cloth, metallic mesh screen, and/or other matrix that is capable of collecting electrons from the surface of the ACC. The AE is preferably a layer of micro-thin carbon paper with a platinum/ruthenium catalyst pressed into it. And the PEB preferably includes membranes provided under the trademark NAFION, which include membranes commercially provided by DuPont of Wilmington, Del. USA, wherein NAFION membranes include electrolytes and membrane electrode assemblies with maximum performance and durability and provide the essence of a proton exchange membrane that allows protons to pass through but prevents electrons from passing through the membrane; the PEB is included in the fuel diffusion layer. Preferably, the Fuel Impermeable Membrane (FIM) provides a substantial or total fuel barrier, the FIM including palladium, or other suitable materials, deposited by nanotechnology-based processing or by foil pressing. In the present invention, the Cathode Electrode is essentially the same material as the anode electrode but separated here because preferably the catalyst concentrations vary between the two; and the Cathode Current Collector is essentially the same material as the anode current collector but separated here because preferably the cathode side uses different materials than the anode.

FIG. 4 provides a schematic diagram illustrating the operation of a fuel cell and membrane according to the present invention. Such a fuel-impermeable membrane for a fuel cell includes a proton exchange membrane (PEM) 20 having an energy loss of less than about 100 mA cm⁻² of active surface area, thereby providing an energy efficient fuel cell.

Preferably, and significantly, the PEM is a nano-film that is formed by nano-deposition. In a preferred embodiment of the present invention, the nano-deposition is provided as set forth in U.S. Pat. No. 5,476,535, which is incorporated herein by reference in its entirety. These methods include providing a soluble gas that is introduced in a melt material and then atomized and rapidly cooled. The cooling drives the gas from solution, further disintegrating the atomized material to an ultra-fine powder. In one embodiment the atomization and rapid cooling are effected using a gas atomization die. Introduction of the soluble gas may be effected by addition of reactive constituents to the melt, for reactively forming such gas. Finer powders with desirable metallurgical properties for use with the present invention are formed using a metallic melt. Other methods for providing nano-film formation that provide suitable nano-deposition of a film for use as a PEM as set forth herein are alternatively used with the present invention for forming a PEM and a fuel cell with such a PEM.

Preferably, specifications relating to the membrane itself are similar to that of the NAFION 115 or 117 polymer insomuch as its relationship to the nano-film deposition of the barrier material (Palladium). Preferably, the present invention includes the components associated with an entire MEA (membrane electrode assembly) with the catalyst loading of the barrier, membrane film, and electrodes as for the commercial membrane under NAFION as set forth hereinabove.

As illustrated in FIG. 6, a fuel cell having a substantially fuel-impermeable membrane according to the present invention includes:

a fuel cell case;

a fuel reservoir on the anode side;

a cathode side cover;

a fuel diffusion layer;

a membrane electrode assembly having:
an Anode Current Collector (ACC);
an Anode Electrode (AE);
a Polymer Electrolyte Base (PEB);
a Fuel Impermeable Membrane;
a Cathode Electrode; and
a Cathode Current;
   wherein the fuel-impermeable membrane for the fuel cell further includes
   a proton exchange membrane (PEM) having an energy loss less than about 100 mA cm⁻² of active surface area, thereby providing an energy efficient fuel cell.

Thus, the present invention fuel-impermeable membrane and fuel cells made therewith provides a fuel cell proton exchange membrane that blocks fuel crossover between the anode and cathode of the fuel cell, i.e., it functions as a barrier to fuel leakage between components within the fuel cell housing. The fuel source or fuel may be any fuel used within a fuel cell, by way of example and not limitation, methanol is one fuel source that the majority of fuel cell development and research employs. However, it must be noted that other fuel types, i.e., hydrogen carriers, are also intended to be included in the use of the term fuel for the purpose of this application; therefore, the fuel-impermeable membrane is intended to apply as a barrier to leakage or transfer of fuel of any type across or through the membrane. Again, by way of example and not limitation, other fuels include, but are not limited to, liquid or gaseous state of hydrogen, ethanol, alcohols, ethers, petroleum distillates, water (for dilution in alcohol fuel cells), acids, natural gas, and propane. For the purpose this application, unless specified otherwise, any or all of the above hydrogen carriers will be considered as fuel. By way of example, water, apart from being the primary liquid for dilution in alcohol fuel cells, may be used for fuel cells powered in reverse to produce hydrogen from water, where it is particularly important to ensure that the water does not leak back through the membrane to avoid decreasing hydrogen output efficiency, among other things. Thus the barrier membrane is considered to be functional or operable to apply to any fuel source that could be used in a fuel cell or to prevent water leakage for a fuel cell operating in reverse, supra.

Palladium is provided as the most preferable material for a methanol barrier or fuel-impermeable membrane because its physical and chemical properties allow it to block the passage of liquids but allow conducting of hydrogen ions, which provides preferable functionality and operability of the membrane according to the present invention. However, other materials may also be included and/or used as a barrier material. In the present invention, the barrier effectively blocks fuel crossover but allows hydrogen, or hydrogen ions to pass through or across between the anode and cathode of a fuel cell membrane in either direction, as shown in FIG. 4.

The schematic shown in FIG. 1 shows typical PRIOR ART molecular exchanges between the anode and cathode of a direct methanol fuel cell (DMFC). Through catalytic separation the methanol and water are separated into carbon dioxide, protons, and electrons. The size of the arrows is an indicator of the proportion of molecular transfer. The majority of the CO₂ on the anode side is exhausted while a portion crosses over and poisons the cathode. A small amount of water passes from the anode side to the cathode and to some extent vice-versa. The crossover of methanol is noted but the detrimental reaction at the cathode is represented with the greater size arrow to the right of the cathode CO₂. That oxidation of CO₂ is the cause for the greatest loss of fuel cell efficiency by its displacement of H⁺ and O₂ oxidation at the cathode interface. One can note from this diagram that a fuel impermeable barrier has the potential to block the less significant molecular exchanges of water and carbon dioxide thus creating another potential efficiency gain within a fuel cell.

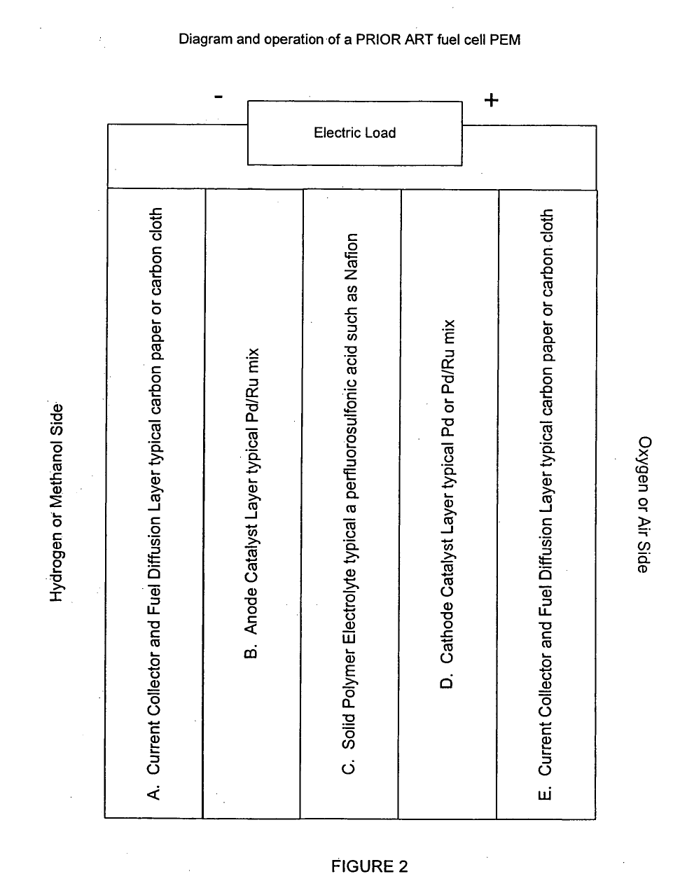

FIG. 2 shows a typical PRIOR ART MEA in its simplest form showing five active surfaces. The anode side or hydrogen side represents the fuel feed side of a fuel cell and the cathode is the oxygen side. Hydrogen [H₂] diffuses through (A) the current collecting material. H₂ comes in contact with (B) the catalyst and is separated into H⁺ protons and H⁻ electrons. The electrolyte (C) allows the protons to pass through but blocks the electrons. The electrons are collected by (A) and follow the circuit to (E) while oxygen diffuses through (E) and makes contact with the protons at the catalyst layer (D) and (acquires electrons that have gone through the circuit) through oxidation forms water.

For the purpose of specifically differentiating between a membrane with a barrier and an impermeable membrane is that a membrane with a barrier is similar to mechanically fastening a thin film to the polymer electrolyte base. An impermeable membrane provides that the electrolyte material itself is the barrier. In other words, through the use of nanotechnology and thin film deposition, the present invention provides a single, unitary and integral electrolyte assembly that embodies the characteristics of the foil press barrier method. In the present invention, a membrane structure is or includes a fuel-impermeable layer or film that is embedded in a membrane or membrane assembly specifically for the purpose of preventing fuel crossover. The membrane structure provides a proton exchange membrane (PEM) or, if used in conjunction with electric current collectors, a membrane electrode assembly (MEA), thereby providing fuel impermeable membrane assembly (FIMA). If used in the context with the fuel cell electric current collectors, then it functions as a fuel impermeable membrane electrode assembly or FIMEA. More particularly, for a methanol-impermeable barrier or membrane, a methanol specific membrane (MIMA or MIMEA) is provided.

More specific membrane component detail, as shown in FIG. 4, illustrates a PEM that is referred to as a solid polymer electrolyte by definition of its function within the fuel cell. The majority of methanol fuel cell research and development has focused on using perfluorocabonsulfonic acid-based ionomers, of which NAFION is prototypical. NAFION is a commercially available polymer called NAFION sold by DuPont as the specific PEM solid polymer electrolyte. NAFION is widely used for proton exchange membrane (PEM) fuel cells and water electrolyzers. The membrane performs as a separator and solid electrolyte in a variety of electromechanical cells which require the membrane to selectively transport cations across the cell junction. The polymer is chemically resistant and durable. A preferred embodiment of the present invention itself includes NAFION as the PEM electrolyte. However, this selection was provided for commercial availability and functionality, and should not be taken to be a limitation of the present invention, as other possible electrolytes including solid, liquid, gaseous, or otherwise may be used with the present invention.

Fuel crossover impact is illustrated in FIG. 1. As stated previously Nafion has been the leading solid polymer electrolyte used as the PEM. Fuel crossover rate is difficult at best to measure, at least with any form of accuracy. Nevertheless, a loss of about 100 mA cm⁻² of active proton exchange membrane (PEM) surface area is a generally accepted typical crossover rate; meaning that 100 mA of potential useable power for every square centimeter of membrane area is wasted. With a typical cell output of 500 mA cm⁻², the 100 mA loss is significant approximately—⅙ of the available energy. The present invention provides a fuel cell membrane that is highly impermeable to fuels for reducing fuel cross-over and, correspondingly, improving energy efficiency of the fuel cell. With the present invention, the membrane has a loss of less than about 100 mA cm⁻² of active PEM, preferably between about 0 and about less than 100 mA cm⁻², more preferably between about 10 to about 50 mA cm⁻².

One fuel cell mechanical design using a FIMA may be suitable for the method of embedding or deposition of the barrier material into or onto a PEM to convert the PEM to a FIMA by using nanotechnology methods.

Certain modifications and improvements will occur to those skilled in the art upon a reading of the foregoing description. All modifications and improvements have been deleted herein for the sake of conciseness and readability but are properly within the scope of the following claims.

What is claimed is:

1. A fuel-impermeable membrane for a fuel cell comprising
a proton exchange membrane (PEM) having an energy loss of less than about 100 mA cm⁻² of active surface area, thereby providing an energy efficient fuel cell.

2. The membrane of to claim 1, wherein the PEM is a nano-film.

3. The membrane of to claim 1, wherein the PEM is provided by nano-deposition.

4. The membrane of claim 1 wherein the PEM comprises palladium.

5. The membrane of claim 1 wherein the PEM consists of palladium.

6. A fuel cell having efficient electrochemical conversion comprising:
a fuel cell case;
a fuel reservoir on the anode side;
a cathode side cover;
a fuel diffusion layer; and
a membrane electrode assembly having:
an Anode Current Collector (ACC);
an Anode Electrode (AE);
a Polymer Electrolyte Base (PEB);
a Fuel Impermeable Membrane;
a Cathode Electrode; and
a Cathode Current;
wherein the fuel-impermeable membrane further comprises
a proton exchange membrane (PEM) having an energy loss less than about 100 mA cm⁻² of active surface area, thereby providing an energy efficient fuel cell.

7. The membrane of to claim 6, wherein the PEM is a nano-film.

8. The membrane of to claim 6, wherein the PEM is provided by nano-deposition.

9. The membrane of claim 6, wherein the PEM comprises palladium.

10. The membrane of claim 6, wherein the PEM consists of palladium.

11. A method for forming a fuel-impermeable membrane for a fuel cell comprising the steps of:
forming a proton exchange membrane (PEM) having an energy loss of less than about 100 mA cm⁻² of active surface area, wherein the PEM is formed as a nano-film by nano-deposition;
providing a fuel cell including the PEM for providing an energy efficient fuel cell.

12. The method of claim 1 1, wherein the PEM comprises palladium.
